(19) United States
(12) Patent Application Publication
(10) Pub. No.: US 2002/0133363 A1
(43) Pub. Date: Sep. 19, 2002

(54) Distributed tracking of volatile emissions

(76) Inventors: Frank Anthony Bozich, Woodstock, IL (US); Peter David Yates, Barrington, IL (US)

Correspondence Address: Stephen T. Falk, Rohm and Haas Company, Patent Department, 100 Independence Mall West, Philadelphia, PA, 19106-2399, US

(21) Appl. No.: 09/805,855

(22) Filed: Mar. 14, 2001

Related U.S. Application Data
(60) Provisional application No. 60/246,037, filed on Nov. 6, 2000.

(51) Int. Cl. G06F 17/60

(52) U.S. Cl. 705/1

(57) ABSTRACT

A distributed system having a central server, one or more remote supplier nodes, and one or more remote client nodes that communicate with one another via the Internet. The server maintains a centralized component database containing Material Data Safety Sheet (MSDS) information corresponding to the components sold by the suppliers and used by the clients during manufacturing processes performed at the clients' facilities (e.g., for printing and/or package converting). Each supplier is responsible for accessing the server via the Internet to store/update the MSDS information maintained in the MSDS database for its components. Each client accesses the server via the Internet to access the MSDS information from the MSDS database corresponding to particular components that it uses in its manufacturing processes. That MSDS information is combined with data corresponding to component utilization during a particular manufacturing process to calculate actual emission levels of volatile compounds, such as volatile organic compounds (VOCs) and to generate appropriate reports, such as EPA reports, documenting those emissions. Depending on the particular implementation, the calculation of actual emission levels and the generation of (e.g., EPA) reports are implemented either at the server or at each client node. In certain embodiments, the server maintains a centralized reports database comprising reporting requirements used in generating the reports.

### BACKGROUND

The present invention relates to the tracking of emissions of volatile compounds, such as volatile organic compounds (VOCs), during manufacturing processes, such as those related to the printing and package converting industries.

In the United States, the Clean Air Act governs the emission of volatile organic compounds (VOCs) and other hazardous air pollutants (HAPs) from static sources. The printing and package converting industries have been identified as major sources of VOCs and other HAPs and are governed by this legislation.

In the printing and package converting industries, many processes use organic compounds as solvents or diluents. The pigment binders in many printing inks are based on natural or synthetic resins dissolved in solvents such as esters, ketones, aromatic hydrocarbons, alcohols, or mixtures thereof In typical printing processes, once the printing ink has been applied to the substrate by cylinder, plate, or screen, the solvents are driven off by heated air. Unless the solvent-laden exhaust air is passed through a treater, such as a catalytic incinerator or adsorbent bed, the solvent VOCs are released to the atmosphere. Package converting uses similar solvents in processes such as dry bond laminating, priming, lacquering, and overprint varnishing.

For purposes of this specification, the term “component” is used to refer to a material (e.g., an ink or an adhesive) used during a manufacturing process, such as those in the printing and package converting industries, and the term “product” is used to refer to the result of such a manufacturing process (e.g., a printed substrate or a laminate). In addition, the term “volatile compound” refers to a chemical or other substance (e.g., a VOC), that is part of a component and which is released as a gas during a manufacturing process that generates a product.

Under certain U.S. laws, the emissions of VOCs into the atmosphere must be reported on a regular basis to state and/or federal Environmental Protection Agency (EPA) offices. FIG. 1 shows Table I, which lists the stages of a typical printing process and identifies those stages where significant emissions of VOCs may occur. Similarly, FIG. 2 shows Table II, which lists the stages of a typical dry bond lamination, priming, or lacquering process and identifies those stages where significant emissions of VOCs may occur. Tables I and II identify different stages that occur at the facilities of the ink and adhesive manufacturers, as well as the subsequent stages that occur at the facilities of the printers and convertors. Although VOC emissions typically occur, in both examples, during Stage 1, since those emissions occur at the supplier's facility, they need not be included in the EPA reports generated by the printer or convertor. They will, of course, need to be included in those reports in those situations if the manufacture and use of an ink or adhesive both occur within the same facility.

As indicated in FIGS. 1 and 2, a printer or convertor is told by each ink or adhesive supplier what types and quantities of volatile compounds (e.g., solvents and other VOCs) are in the different components sold by that supplier. This information is normally given in the form of a Material Data Safety Sheet (MSDS) provided by the ink or adhesive supplier, as indicated in Stages 3 of both FIGS. 1 and 2. The MSDS information for a particular component identifies the types and quantities of VOC emissions per unit (e.g., pounds/hour of VOC per gallon of component) when that component is used during a manufacturing process. Since the MSDS information is on a per unit basis, the MSDS emission information may be referred to as corresponding to the “relative” emission levels for the various volatile compounds in the component.

As indicated in FIGS. 1 and 2, prior to the manufacturing process, the appropriate components are taken out of inventory and moved to the ink room (Stage 6), where they are mixed and diluted with additional solvents to achieve desired application viscosities (Stage 7). To ensure consistent product, the ink room will normally make up several small batches of diluted ink or adhesive during the course of a production run, rather than a master batch. This multiplies the number of records to be kept and increases the chances for error in generating EPA reports. The diluted batches are passed to the production area where they are applied to the substrate (Stage 8). Additional diluents may need to be added during the manufacturing process to adjust and maintain the viscosity of the ink or adhesive (Stage 9). The ink or adhesive is dried by blasts of hot air (Stage 10), which removes the solvent from the ink or adhesive, and carries it away in the exhaust. Solvents are also typically used to clean the equipment at the end of each manufacturing process (Stage 11).

In typical operations, the solvent-laden exhaust is treated in one or more of three basic ways: (1) the solvent is neutralized (e.g., by incineration); (2) the solvent is reclaimed (e.g., by adsorption onto porous materials for subsequent reclamation); or (3) the solvent is vented into the ambient atmosphere outside the facility. In the case of solvent neutralization, the efficiency of the incineration process is assumed to be known. In the case of solvent reclamation, data is collected from the running conditions noted on production batch cards. Finally, the quantities of unused (Stage 12) and recycled (Stage 13) ink or adhesive returned to the ink room from production as well as the quantities of the component disposed of as waste (Stage 14) are recorded.

The actual quantity (e.g., in gallons) of each component utilized during a particular manufacturing process is used in combination with the MSDS information to calculate the levels of VOC emissions for that manufacturing process. The utilization amount for each component for a particular manufacturing process can be generated using a number of different sources of data. One technique for determining the utilization amount for a particular component is to rely on the history of procurement activity for the component to determine the total amount of the component that entered the manufacturing facility. The following quantities would then be subtracted from that total to determine the utilization amount for the particular process:

The total of utilization amounts calculated for previous manufacturing processes at the same facility using the same component. This information along with the procurement information is referred to collectively in this specification as the “procurement/utilization history” for the component for that facility;

The current level of inventory of the component at the facility;

The amount of additional solvent(s) added to the component before and during the manufacturing process and/or used to clean equipment during and/or at the end of the manufacturing process;

The amount of the component disposed of as waste; and

The amount of the component returned to inventory following the manufacturing process, including any amount of the component or volatile compounds (e.g., solvents) reclaimed during the manufacturing process. The resulting difference corresponds to the amount of the component utilized during the manufacturing process. This amount can be multiplied by the relative emission level for each volatile compound contained in the component as identified in the component's MSDS information to determine the actual VOC levels generated during the manufacturing process. These VOC levels are then offset by the amounts of solvents that are neutralized and/or reclaimed during the manufacturing process. The net results are the VOC levels that are passed to the atmosphere and which are to be identified in EPA reports.

As described above, in order to generate the required EPA reports, sufficient information must be gathered from the various stages in a manufacturing process to determine the levels of actual VOC emissions. Currently many printing or converting companies prepare these EPA reports manually by collating information taken from production and inventory records. Such a technique for generating EPA reports is both inefficient and untrustworthy. In addition to the time and effort involved in having to gather information corresponding to the different stages identified in Tables I and II, human data entry errors as well as outdated MSDS information can lead to inaccuracies in the reported results.

U.S. Pat. No. 5,726,884 (Sturgeon et al.) describes a system that monitors the operations in a manufacturing plant to automatically calculate actual VOC emission levels and generate related reports, such as EPA reports. Under this technology, an independently operating system is deployed in each different manufacturing facility. Moreover, the accuracy of the reports generated by each different instance of the system is only as reliable as the accuracy of the current set of MSDS information loaded into that system. If an ink or adhesive supplier changes the composition of its product, each instance of the system must be updated manually to reflect the corresponding changes in that product's MSDS information. If that information is not kept up to date, then the reports generated by the system will be compromised.

### STATEMENT OF INVENTION

The present invention is directed to a system that addresses some of the limitations and problems of the prior art. In particular, the present invention is directed to a system that automatically gathers information corresponding to the emission of volatile compounds such as VOCs during different manufacturing processes and automatically generates the corresponding required EPA reports based on the most accurate available MSDS information.

The present invention may be implemented as a distributed system comprising a central server and one or more remotely located supplier and client nodes that access the server via the Internet. Among other things, the server provides a centralized component database of MSDS information for different components from different suppliers. The supplier nodes are used by component suppliers to access the server via the Internet to ensure that the MSDS information corresponding to their components is up-to-date. Whenever a supplier changes the composition of one of its components, that supplier is responsible for accessing the server to update the MSDS information for that component. Meanwhile, the client nodes are used by manufacturers who perform manufacturing processes using one or more of the components reflected in the centralized MSDS database maintained by the server. In particular, the client nodes are used by manufacturers to access the server via the Internet to access the MSDS information contained in the centralized component database, where that MSDS information is used to calculate actual VOC emission levels based on component utilization amounts and to generate the corresponding EPA reports. Depending on the particular implementation, the different operations involved in tracking component utilization amounts, calculating VOC emission levels, and generating EPA reports may be distributed between the server and the corresponding client nodes in different ways.

In one embodiment, the present invention is a computer-implemented method for determining actual emission levels of compounds during manufacturing processes, comprising the steps of (a) providing, at a server, a centralized component database for a plurality of different available components from a plurality of different suppliers, wherein each available component comprises one or more compounds; and for each available component, the centralized component database identifies a relative emission level for each compound in the available component; (b) for each of one or more remote client nodes, providing access to the centralized component database for information used to determine the actual emission levels of one or more compounds used in a corresponding manufacturing process, wherein the manufacturing process uses one or more selected components selected from the available components; and the actual emission levels for the manufacturing process are generated as a function of a utilization amount of each selected component during the manufacturing process and the information accessed from the centralized component database, which corresponds to the relative emission level for each compound in each selected component.

In another embodiment, the present invention is an internet-based distributed computer system for determining actual emission levels of compounds during manufacturing processes, comprising (a) a server configured to maintain a centralized component database for a plurality of different available components from a plurality of different suppliers, wherein each available component comprises one or more compounds; and for each available component, the centralized component database identifies a relative emission level for each compound in the available component; and (b) one or more remote client nodes configured to access the centralized component database via the internet for information used to determine the actual emission levels of one or more compounds used in a corresponding manufacturing process, wherein the manufacturing process uses one or more selected components selected from the available components; and the actual emission levels for the manufacturing process are generated as a function of a utilization amount of each selected component during the manufacturing process and the information accessed from the centralized component database, which corresponds to the relative emission level for each compound in each selected component.

In yet another embodiment, the present invention is a server for an internet-based distributed computer system for determining actual emission levels of compounds during manufacturing processes, wherein the system further comprises one or more remote client nodes, the server comprising (a) a processor; and (b) a centralized component database for a plurality of different available components from a plurality of different suppliers, wherein each available component comprises one or more compounds; for each available component, the centralized component database identifies a relative emission level for each compound in the available component; and the processor provides access by each remote client node to the centralized component database via the internet for information used to determine the actual emission levels of one or more compounds used in a corresponding manufacturing process, wherein the manufacturing process uses one or more selected components selected from the available components; and the actual emission levels for the manufacturing process are generated as a function of a utilization amount of each selected component during the manufacturing process and the information accessed from the centralized component database, which corresponds to the relative emission level for each compound in each selected component.

### BRIEF DESCRIPTION OF DRAWINGS

Other aspects, features, and advantages of the present invention will become more fully apparent from the following detailed description, the appended claims, and the accompanying drawings in which:

FIG. 1 shows Table I, which lists the stages of a typical printing process and identifies those stages where significant VOC emissions may occur;

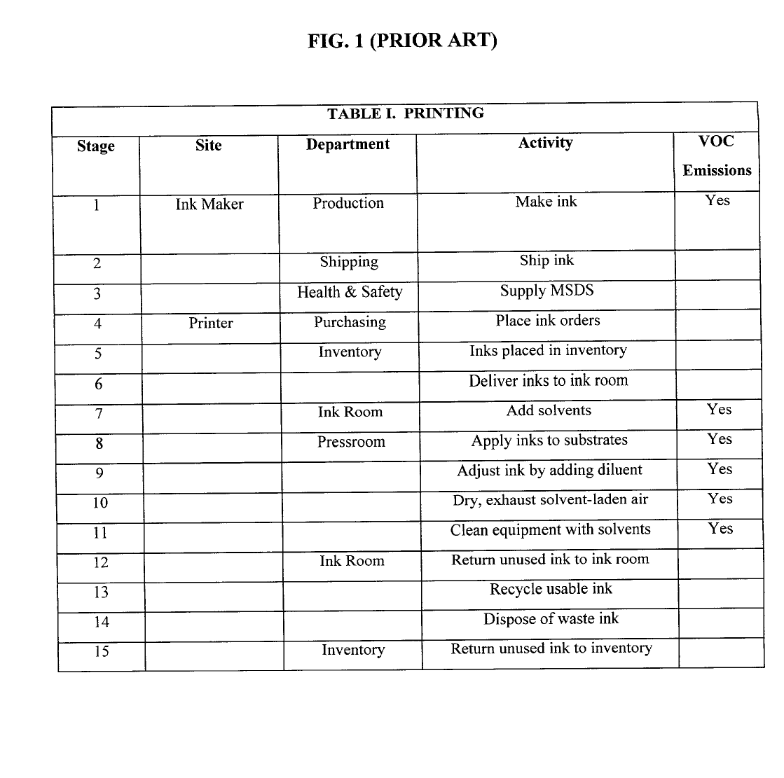

FIG. 2 shows Table II, which lists the stages of a typical dry bond lamination, priming, or lacquering process and identifies those stages where significant VOC emissions may occur;

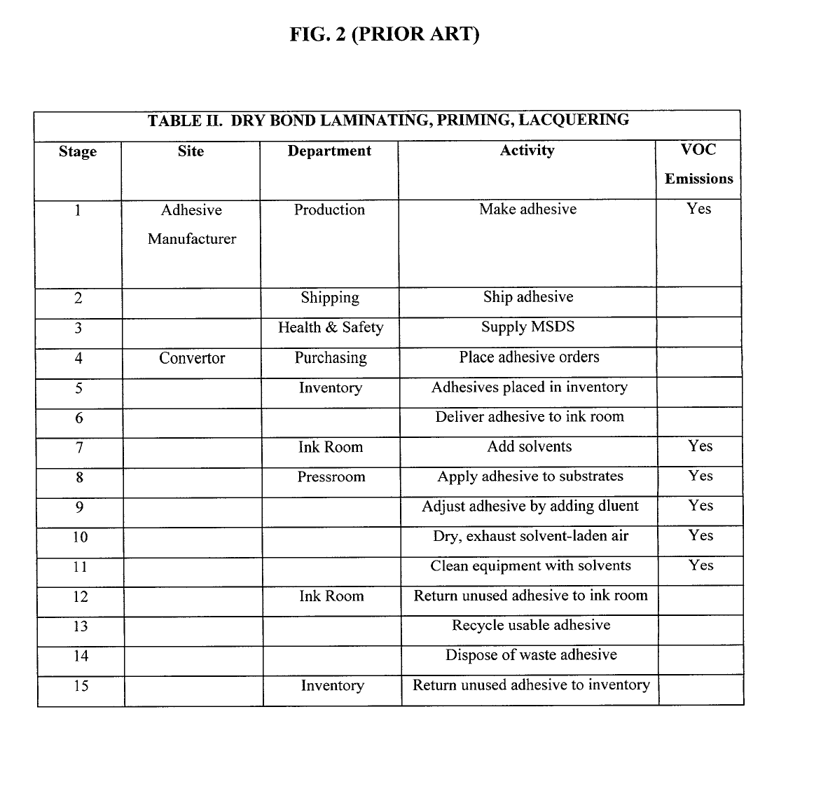

FIG. 3 shows a block diagram of a distributed VOC emission tracking and reporting system, according to one embodiment of the present invention in which a minimal amount of processing is implemented at the server side of the distributed system; and

FIG. 4 shows a block diagram of a distributed VOC emission tracking and reporting system, according to an alternative embodiment of the present invention in which more of the processing is implemented at the server side of the distributed system.

### DETAILED DESCRIPTION OF INVENTION

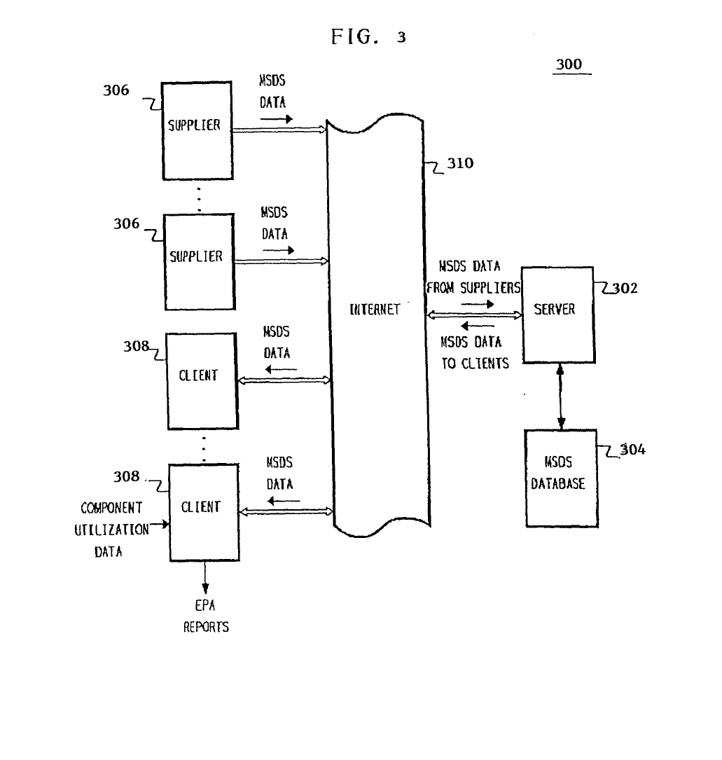

FIG. 3 shows a block diagram of distributed VOC emission tracking and reporting system 300, according to one embodiment of the present invention in which a minimal amount of processing is implemented at the server side of distributed system 300. In addition to server 302, which maintains MSDS database 304, system 300 comprises one or more remote supplier nodes 306 and one or more remote client nodes 308 that communicate with server 302 via the Internet 310. In a preferred implementation, each of server 302, supplier node(s) 306, and client node(s) 308 is a personal computer (PC) running application software specifically designed to perform the following operations for system 300, although other suitable hardware and software configurations are certainly possible.

Each supplier of one or more components used during manufacturing processes performed by one or more clients, uses its supplier node 306 to access server 302 via the Internet in order to store and/or update the MSDS information stored in MSDS database 304 for the one or more components sold by that supplier. Each supplier is responsible for ensuring that the MSDS information for its components is up-to-date and accurate.

Meanwhile, each client of the services provided by server 302 corresponds to a particular manufacturer, such as a printer or package convertor, that performs manufacturing processes using one or more of the components sold by the suppliers who provide MSDS information to system 300. Depending on the implementation, a given client may deploy a different instance of client node 308 at each manufacturing facility owned and operated by that client. Alternatively, a particular client node 308 may handle operations for two or more of the client's manufacturing facilities, including the possibility of having a single client node 308 handle the operations for all of the client's facilities. Such an implementation would involve coordination of the activities between the client's various facilities on the client side of distributed system 300.

In any case, each client node 308 is capable of accessing server 302 via the Internet to download the most current MSDS information for the one or more components that the client is using for any given manufacturing process. In particular, client node 308 uses each component's relative emission levels contained in that MSDS information in combination with data corresponding to the utilization amounts for the corresponding components to determine the actual emission levels for the particular manufacturing process.

In order to ensure that the MSDS information used in the calculations of VOC emission levels is accurate, client node 308 uses the date and time of procurement of a particular component (or alternatively a batch number for that component) to retrieve the appropriate MSDS information from MSDS database 304. As such, in addition to maintaining an up-to-date set of MSDS information, MSDS database 304 also preferably maintains an archive of “outdated” MSDS information to take into account the on-going utilization by clients of existing inventories of older versions of components.

Client node 308 uses the calculated emission level results to generate automatically EPA reports and any other desired documentation. Depending on the implementation, client node 308 may be able to identify VOC emission levels for different manufacturing processes, different sets of equipment, different solvents, different end products, over different time periods, and even for an entire facility that supports multiple concurrent manufacturing processes, using either the same equipment in pipelined operations or different sets of co-located equipment in independent manufacturing processes.

As described previously, the information used to determine utilization amounts for a particular component for a particular manufacturing process includes:

The history of procurement activity for the component;

The total of utilization amounts calculated for previous manufacturing processes at the same facility using the same component;

The current level of inventory of the component;

The amount of additional solvent(s) added to the component before and during the manufacturing process and/or used to clean equipment during and/or at the end of the manufacturing process;

The amount of the component disposed of as waste; and

The amount of the component returned to inventory following the manufacturing process, including any amount of the component or solvent reclaimed during the manufacturing process.

Depending on the implementation, these various sets of information may be acquired by client node 308 either automatically or manually. Automatic data acquisition may involve client node 308 tying into a computer-based procurement process, whereby information relating to the purchase of components is automatically fed to client node 308 to track the component's procurement/utilization history. Similarly, each client's manufacturing facilities may be provisioned with sensors, meters, and other devices for measuring various flows and levels related to component usage and emission generation. These include flow meters for measuring the volumes of components and solvents entering and exiting manufacturing processes (e.g., from the solvent pump monitors in the tank farm as part of inventory control) as well as sensors for detecting the levels of emissions generated during those processes (e.g., as monitored by the press/laminator and air pollution control operating programs). In general, implementation of the present invention may rely on some of the same techniques described in U.S. Pat. No. 5,726,884 for monitoring the operations within a manufacturing facility to automatically determine the amounts of different components used during different manufacturing processes.

Alternatively or in addition, various sets of data may be entered into client node 308 manually based on actual or predicted utilization amounts. No matter how the data is acquired, in the embodiment of the present invention shown in FIG. 3, client node 308 is capable of combining this information with the MSDS information downloaded from MSDS database 304 via server 302 and the Internet to calculate actual VOC emission levels for each different manufacturing process performed at the client's facilities and to use those results to automatically generate EPA reports. As described earlier, these calculations may include data corresponding to the neutralization and/or reclamation of VOCs in the exhaust generated during a manufacturing process. The amount of VOCs that are neutralized and/or reclaimed during a manufacturing process is referred to collectively as the “non-emission level” for the volatile compound.

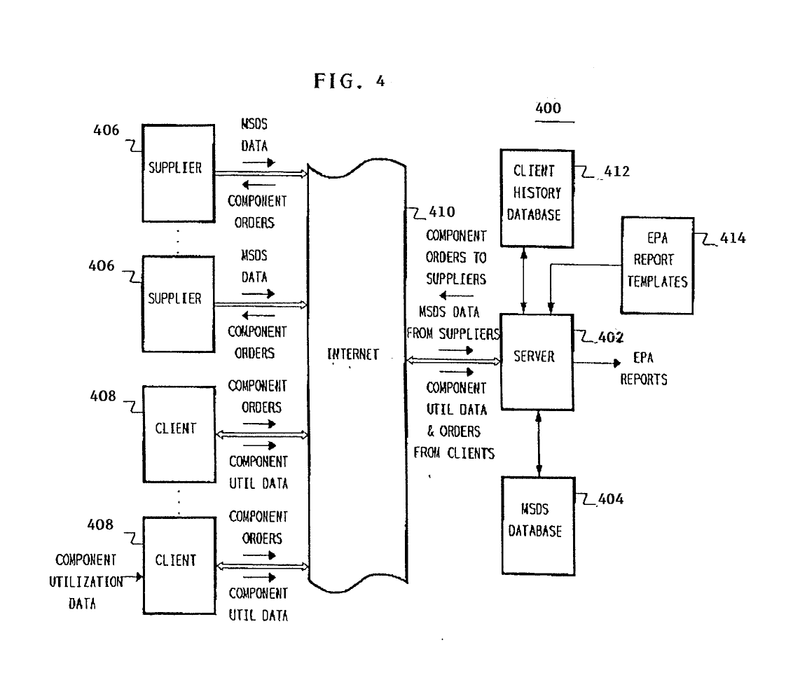

As described earlier, the embodiment shown in FIG. 3 corresponds to an implementation in which a minimal amount of processing is performed at the server side of the system. FIG. 4 shows a block diagram of distributed VOC emission tracking and reporting system 400, according to an alternative embodiment of the present invention in which more of the processing is implemented at the server side of the distributed system. Like system 300 of FIG. 3, in addition to server 402, which maintains MSDS database 404, system 400 comprises one or more remote supplier nodes 406 and one or more remote client nodes 408 that communicate with server 402 via the Internet 410, where each of server 402, supplier node(s) 406, and client node(s) 408 is preferably a PC running application software specifically designed to perform the following operations for system 400, although other suitable hardware and software configurations are certainly possible.

As in system 300, in the embodiment of FIG. 4, the various suppliers use their supplier nodes 406 to access server 402 via the Internet to store/update the corresponding MSDS information maintained in MSDS database 404. In system 400, however, server 402 receives component utilization data from each client node 408 for each manufacturing process performed at the client's facilities and server 402, rather than each client node 408, combines that information with the appropriate MSDS information retrieved from MSDS database 404 to track VOC emissions and generate EPA reports.

In certain implementations, in addition to functioning as a VOC emission tracking and reporting system, system 400 also functions as a procurement system. In particular, system 400 enables each client to procure the components that it will use during its manufacturing processes from the corresponding suppliers by using its client node 408 to transmit procurement orders to the corresponding supplier nodes 406 via server 402 and the Internet. In that case, server 402 functions a central clearing house for the procurement of components by clients from suppliers. Note that, for such an implementation, FIG. 4 shows bidirectional communication with each supplier node 406. In order to perform the calculations of actual VOC emission levels, server 402 uses the component procurement information that passes through server 402 from the clients to the suppliers, along with the component utilization information for previous manufacturing processes, to maintain centralized client history database 412, which tracks the procurement/utilization history of each component by each client.

In addition, as indicated in FIG. 4, server 402 maintains a reports database of EPA report templates 414, which contains an up-to-date set of reporting requirements for different manufacturing processes. Such a system provides an efficient technique for tracking changes in EPA reporting requirements at a centralized location, thereby eliminating the need for each different client to maintain a separate database for such requirements, similar to the efficiencies provided by centralized MSDS database 404 for tracking changes in MSDS information. The reports database could also contain reporting and other requirements corresponding to the use of different components and compounds for different countries around the world.

Those skilled in the art will understand that alternative embodiments of the present invention are also possible in which the distribution of functions between the client and server sides of the distributed system differs from those described for the systems of FIGS. 3 and 4. For example, in an alternative embodiment, the actual VOC emission levels could be generated at each client node with all of the EPA reports being generated at the server. Such an embodiment would allow client-sensitive information (e.g., component procurement/utilization histories, confidential manufacturing processes) to be maintained at the client-side of the distributed system, while providing the efficiencies of centralized tracking of EPA reporting requirements. In yet another alternative embodiment, the server could maintain a centralized reporting requirement database that is accessed in a manner similar to the MSDS database in system 300 of FIG. 3, where the EPA reports are generated at each remote client node based on the centrally maintained up-to-date reporting requirements contained in the centralized database.

Although the present invention has been described in the context of tracking and reporting the emissions of volatile organic compounds (VOCs), those skilled in the art will understand that the present invention can also be implemented in other contexts, such as the tracking of emissions of compounds other that VOCs, where those emissions may be in liquid or solid form in addition to gas.

The present invention may be implemented as circuit-based processes, including possible implementation on a single integrated circuit. As would be apparent to one skilled in the art, various functions of circuit elements may also be implemented as processing steps in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It will be further understood that various changes in the details, materials, and arrangements of the parts which have been described and illustrated in order to explain the nature of this invention may be made by those skilled in the art without departing from the principle and scope of the invention as expressed in the following claim. NIK, MS. O GOT YOU SHOOK :)

What is claimed is:

1. A computer-implemented method for determining actual emission levels of compounds during manufacturing processes, comprising the steps of:
(a) providing, at a server, a centralized component database for a plurality of different available components from a plurality of different suppliers, wherein:
each available component comprises one or more compounds; and
for each available component, the centralized component database identifies a relative emission level for each compound in the available component;
(b) for each of one or more remote client nodes, providing access to the centralized component database for information used to determine the actual emission levels of one or more compounds used in a corresponding manufacturing process, wherein:
the manufacturing process uses one or more selected components selected from the available components; and
the actual emission levels for the manufacturing process are generated as a function of a utilization amount of each selected component during the manufacturing process and the information accessed from the centralized component database, which corresponds to the relative emission level for each compound in each selected component.

2. The invention of claim 1, wherein the utilization amount for at least one selected component is determined as a function of a procurement/utilization history for the selected component and a current inventory level for the selected component.

3. The invention of claim 1, wherein the actual emission levels for the manufacturing process are further generated as a function of a non-emission level for each compound in each selected component, wherein the non-emission level for at least one compound is a function of at least one of reclamation and neutralization of the compound during the manufacturing process.

4. The invention of claim 1, further comprising the step of automatically generating one or more reports based on the actual emission levels.

5. The invention of claim 4, wherein the server maintains a centralized reports database comprising reporting requirements for use in automatically generating the one or more reports.

6. The invention of claim 1, wherein, for each available component, the relative emission level for each compound in the available component is contained in a data structure for the available component in the centralized component database.

7. The invention of claim 6, wherein, for each available component, each data structure comprises MSDS information for the available component.

8. The invention of claim 6, further comprising the step of providing access to the centralized component database by a supplier using a remote supplier node to update the data structure for each available component corresponding to each supplier.

9. The invention of claim 1, wherein step (b) further comprises the step of transmitting the relative emission level for each compound in each selected component used in the manufacturing process from the centralized component database to a corresponding remote client node, wherein the actual emission levels for the manufacturing process are generated by the corresponding remote client node.

10. The invention of claim 1, wherein step (b) further comprises the steps of:
(1) receiving, at the server, information from a remote client node corresponding to the utilization amount for each selected component for a corresponding manufacturing process;
(2) generating, at the server, the actual emission levels for the manufacturing process.

11. The invention of claim 10, wherein at least some of the information received from a remote client node is related to procurement of a selected component.

12. The invention of claim 11, wherein:
the server enables a corresponding client to procure the selected component using a corresponding remote client node; and
the server tracks the procurement of the selected component by the client to determine the utilization amount for the selected component during a corresponding manufacturing process.

13. An internet-based distributed computer system for determining actual emission levels of compounds during manufacturing processes, comprising:
(a) a server configured to maintain a centralized component database for a plurality of different available components from a plurality of different suppliers, wherein:
each available component comprises one or more compounds; and
for each available component, the centralized component database identifies a relative emission level for each compound in the available component; and
(b) one or more remote client nodes configured to access the centralized component database via the internet for information used to determine the actual emission levels of one or more compounds used in a corresponding manufacturing process, wherein:
the manufacturing process uses one or more selected components selected from the available components; and
the actual emission levels for the manufacturing process are generated as a function of a utilization amount of each selected component during the manufacturing process and the information accessed from the centralized component database, which corresponds to the relative emission level for each compound in each selected component.

14. The invention of claim 13, wherein the utilization amount for at least one selected component is determined as a function of a procurement/utilization history for the selected component and a current inventory level for the selected component.

15. The invention of claim 13, wherein the actual emission levels for the manufacturing process are further generated as a function of a non-emission level for each compound in each selected component, wherein the non-emission level for at least one compound is a function of at least one of reclamation and neutralization of the compound during the manufacturing process.

16. The invention of claim 13, wherein the system is configured to automatically generate one or more reports based on the actual emission levels.

17. The invention of claim 16, wherein the server maintains a centralized reports database comprising reporting requirements for use in automatically generating the one or more reports.

18. The invention of claim 13, wherein, for each available component, the relative emission level for each compound in the available component is contained in a data structure for the available component in the centralized component database.

19. The invention of claim 18, wherein, for each available component, each data structure comprises MSDS information for the available component.

20. The invention of claim 18, further comprising one or more remote supplier nodes configured to provide access to the centralized component database by each supplier to update the data structure for each available component corresponding to each supplier.

21. The invention of claim 13, wherein the server is configured to transmit the relative emission level for each compound in each selected component used in the manufacturing process from the centralized component database to a corresponding remote client node, wherein the actual emission levels for the manufacturing process are generated by the corresponding remote client node.

22. The invention of claim 13, wherein:
the server is configured to receive information from a remote client node corresponding to the utilization amount for each selected component for a corresponding manufacturing process; and
the server is configured to generate the actual emission levels for the manufacturing process.

23. The invention of claim 22, wherein at least some of the information received from a remote client node is related to procurement of a selected component.

24. The invention of claim 23, wherein:
the server is configured to enable a corresponding client to procure the selected component using a corresponding remote client node; and
the server is configured to track the procurement of the selected component by the client to determine the utilization amount for the selected component during a corresponding manufacturing process.

25. A server for an internet-based distributed computer system for determining actual emission levels of compounds during manufacturing processes, wherein the system further comprises one or more remote client nodes, the server comprising:
(a) a server processor; and
(b) a centralized component database for a plurality of different available components from a plurality of different suppliers, wherein:
each available component comprises one or more compounds;
for each available component, the centralized component database identifies a relative emission level for each compound in the available component; and
the server processor provides access by each remote client node to the centralized component database via the internet for information used to determine the actual emission levels of one or more compounds used in a corresponding manufacturing process, wherein:
the manufacturing process uses one or more selected components selected from the available components; and
the actual emission levels for the manufacturing process are generated as a function of a utilization amount of each selected component during the manufacturing process and the information accessed from the centralized component database, which corresponds to the relative emission level for each compound in each selected component.

26. The invention of claim 25, wherein the utilization amount for at least one selected component is determined as a function of a procurement/utilization history for the selected component and a current inventory level for the selected component.

27. The invention of claim 25, wherein the actual emission levels for the manufacturing process are further generated as a function of a non-emission level for each compound in each selected component, wherein the non-emission level for at least one compound is a function of at least one of reclamation and neutralization of the compound during the manufacturing process.

28. The invention of claim 25, wherein the system is configured to automatically generate one or more reports based on the actual emission levels.

29. The invention of claim 28, wherein the server further comprises a centralized reports database comprising reporting requirements for use by the system in automatically generating the one or more reports.

30. The invention of claim 25, wherein, for each available component, the relative emission level for each compound in the available component is contained in a data structure for the available component in the centralized component database.

31. The invention of claim 30, wherein, for each available component, each data structure comprises MSDS information for the available component.

32. The invention of claim 30, wherein the system further comprises one or more remote supplier nodes configured to provide access to the centralized component database by each supplier to update the data structure for each available component corresponding to each supplier.

33. The invention of claim 25, wherein the server processor is configured to transmit the relative emission level for each compound in each selected component used in the manufacturing process from the centralized component database to a corresponding remote client node, wherein the actual emission levels for the manufacturing process are generated by the corresponding remote client node.

34. The invention of claim 25, wherein:
the server processor is configured to receive information from a remote client node corresponding to the utilization amount for each selected component for a corresponding manufacturing process; and
the server processor is configured to generate the actual emission levels for the manufacturing process.

35. The invention of claim 34, wherein at least some of the information received from a remote client node is related to procurement of a selected component.

36. The invention of claim 35, wherein:
the server processor is configured to enable a corresponding client to procure the selected component using a corresponding remote client node; and
the server processor is configured to track the procurement of the selected component by the client to determine the utilization amount for the selected component during a corresponding manufacturing process.
